(19) United States
(12) Patent Application Publication
(10) Pub. No.: US 2025/0121596 A1
(43) Pub. Date: Apr. 17, 2025

(54) LIQUID EJECTION HEAD AND ELONGATED HEAD

(71) Applicant: CANON KABUSHIKI KAISHA, Tokyo (JP)

(72) Inventor: SATOSHI KIMURA, Kanagawa (JP)

(21) Appl. No.: 18/912,855

(22) Filed: Oct. 11, 2024

(30) Foreign Application Priority Data
Oct. 13, 2023 (JP) 2023-177839

(51) Int. Cl. B41J 2/165; B41J 2/155

(52) U.S. Cl. CPC B41J 2/16507; B41J 2/155

(57) ABSTRACT

A protection of a liquid ejection head with capping in a simplified manner is provided. A liquid ejection head is a liquid ejection head configured to be attachable to and detachable from a liquid ejection apparatus. This liquid ejection head includes a holding member capable of holding a cap member configured to protect a liquid ejection surface.

### BACKGROUND OF THE INVENTION

### Field of the Invention

The present disclosure relates to a liquid ejection head and an elongated head.

### Description of the Related Art

In a liquid ejection head used in a liquid ejection apparatus, printing is conducted by ejecting a liquid toward a print sheet. In a liquid ejection head, there is a possibility that a liquid near ejection ports is thickened and sticks to inhibit normal ejection, causing printing failures. In a case of reducing the size of an ejection port diameter or using an ink with high viscosity or the like for achieving a high image quality, there is a large concern of printing failures due to thickening of the liquid near ejection ports. Hence, it is possible to suppress thickening of a liquid near ejection ports due to evaporation of the liquid from the ejection ports by capping a liquid ejection head which is not used for ejection with a cap member.

Japanese Patent Laid-Open No. 2018-047659 discloses a technique in which a liquid ejection head is moved in a horizontal direction to a capping position at which a capping member is located and the capping member is moved upward to cap the liquid ejection head in a main body of a liquid ejection apparatus.

There is a demand for conducting protection of a liquid ejection head with capping in a simplified manner.

### SUMMARY OF THE INVENTION

A liquid ejection head according to one aspect of the present disclosure is a liquid ejection head configured to be attachable to and detachable from a liquid ejection apparatus, includes a holding member capable of holding a cap member configured to protect a liquid ejection surface.

Further features of the present invention will become apparent from the following description of exemplary embodiments with reference to the attached drawings.

### BRIEF DESCRIPTION OF THE DRAWINGS

FIG. 1 is a diagram showing a liquid ejection apparatus;

FIG. 2 is a schematic diagram showing circulation paths applied to the liquid ejection apparatus;

FIGS. 3A and 3B are perspective views of a liquid ejection head;

FIG. 4 is a perspective view of the liquid ejection head;

FIG. 5 is a perspective view of a cap holding member;

FIG. 6 is a diagram showing a T-shaped member provided in a cap member; and

FIGS. 7A and 7B are diagrams for explaining a configuration of holding the cap member in the liquid ejection head.

### DESCRIPTION OF THE EMBODIMENTS

Hereinafter, a preferred embodiment of the present disclosure will be described in detail with reference to the attached drawings. Note that the following embodiment is not intended to limit the matters of the present disclosure, and all the combinations of characteristics described in the following embodiment are not necessarily essential for the solution of the present disclosure. Note that the same constituents are denoted by the same reference signs.

A liquid ejection apparatus of the present embodiment includes liquid ejection heads which eject liquids with an inkjet system. Liquid ejection apparatuses such as inkjet printing apparatuses are used for not only printing for home uses but also commercial uses such as business or retail photos, or industrial uses such as drawing electronic circuit or for panel displays. The liquid ejection head of the present embodiment is configured to be attachable to and detachable from the liquid ejection apparatus. Printed matters are required to have high image quality and high durability, and liquid ejection heads capable of ejecting liquids (inks) of various types depending on usages are required. The liquid ejection apparatus of the present embodiment may include one liquid ejection head or may include a plurality of liquid ejection heads.

The liquid ejection head of the present embodiment employs a thermal method which ejects a liquid by generating bubbles by using heat generating elements, but may employ a piezoelectric method or any of other various liquid ejection methods. In addition, the present embodiment is described by giving a liquid ejection apparatus configured to circulate a liquid such as an ink between a tank and the liquid ejection head as an example, but is not limited to the circulation type. For example, a configuration in which tanks are provided respectively on the upstream side and the downstream side of a liquid ejection head, and the liquid in a pressure chamber is caused to flow by causing the liquid to flow from one of the tanks to the other tank without circulating the liquid may be employed.

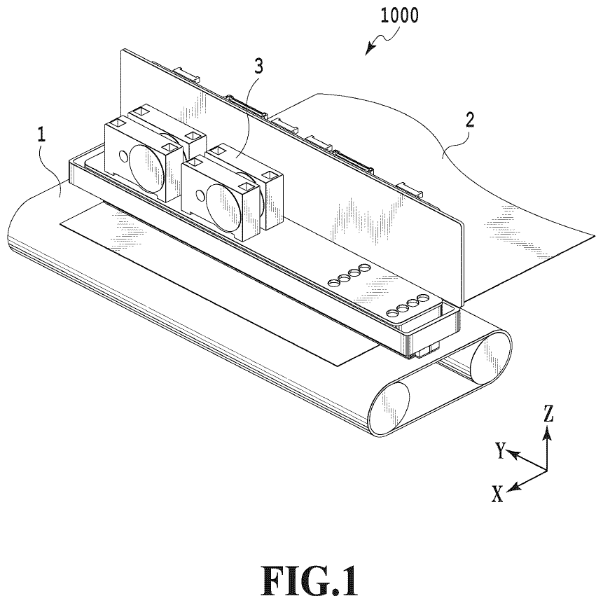

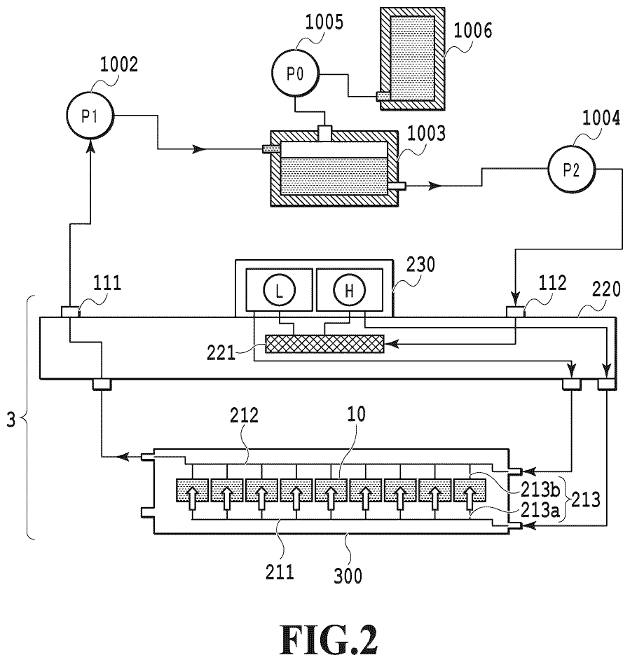

FIG. 1 is a diagram showing a liquid ejection apparatus 1000 configured to eject liquids in the present embodiment. The liquid ejection apparatus 1000 of the present embodiment is an inkjet printing apparatus configured to print by ejecting liquids such as inks. The liquid ejection apparatus 1000 of the present embodiment includes a conveyance unit 1 configured to convey a print medium 2, and an elongated line-type liquid ejection head 3 disposed substantially orthogonally to a conveyance direction of the print medium 2. The liquid ejection apparatus 1000 includes the elongated line-type liquid ejection head 3 configured to conduct continuous printing in one pass while continuously or intermittently conveying a plurality of sheets of the print medium 2. The print medium 2 is not limited to cut paper and may be continuous roll paper. The liquid ejection head 3 is capable of full-color printing using CMYK (cyan, magenta, yellow, and black) inks. To the liquid ejection head 3, liquid supply means which is a supply passage for supplying the liquids to the liquid ejection head 3, liquid collection means for collecting the liquids from the liquid ejection head, a main tank 1006, and a buffer tank 1003 are fluidically connected as described later by using FIG. 2. In addition, to the liquid ejection head 3, a control unit (not shown) configured to transmit electric power and ejection control signals to the liquid ejection head 3 is electrically connected. liquid paths and electric signal paths in the liquid ejection head 3 will be described later. The liquid ejection apparatus 1000 of the present embodiment is an example including one liquid ejection head 3.

FIG. 2 is a schematic diagram showing circulation paths applied to the liquid ejection apparatus 1000 of the present embodiment. FIG. 2 is a diagram in which the liquid ejection head 3 is fluidically connected to a first circulation pump 1002, the buffer tank 1003, and the like. Note that although FIG. 2 shows paths in which the liquid of one color flows among the respective liquids (inks) of CMYK for simplifying the description, in practice, circulation paths for four colors are provided in the liquid ejection head 3 and the main body of the liquid ejection apparatus 1000.

The liquid ejection head 3 includes a liquid supply unit 220 and a liquid ejection unit 300. The liquid supply unit 220 includes a first liquid connecting unit 111, a second liquid connecting unit 112, a filter 221, and a negative pressure control unit 230. The liquid ejection unit 300 includes printing element substrates 10, a common supply flow passage 211, a common collection flow passage 212, individual supply flow passages 213a, and individual collection flow passages 213b. The main body side of the liquid ejection apparatus 1000 includes a first circulation pump 1002, a buffer tank 1003, a second circulation pump 1004, a replenishing pump 1005, and a main tank 1006.

The buffer tank 1003 as a sub tank which is connected to the main tank 1006 includes an air communication port (not shown) through which the inside of the tank and the outside communicate with each other, and is capable of discharging bubbles in the liquid to the outside. The buffer tank 1003 is also connected to the replenishing pump 1005. In a case where the liquid is consumed in the liquid ejection head 3 by ejecting (discharging) the liquid from the ejection ports of the liquid ejection head 3, the replenishing pump 1005 transfers the liquid for the consumption from the main tank 1006 to the buffer tank 1003. Examples of consumption of the liquid from the liquid ejection head 3 include printing or a suction recovery operation which involves ejection of the liquid, and the like.

The first circulation pump 1002 plays a role of drawing the liquid from the first liquid connecting unit 111 of the liquid ejection head 3 to cause the liquid to flow to the buffer tank 1003. The second circulation pump 1004 plays a role of causing the liquid to flow from the buffer tank 1003 to the second liquid connecting unit 112 of the liquid ejection head 3. At the time of driving the liquid ejection head 3, a certain amount of the liquid is caused to flow in the common collection flow passage 212 by the first circulation pump 1002.

The negative pressure control unit 230 is provided in a path between the second circulation pump 1004 and the liquid ejection unit 300. The negative pressure control unit 230 has a function of operating to maintain the pressure downstream of the negative pressure control unit 230 (that is, the liquid ejection unit 300 side) at a constant pressure set in advance even in a case where the flow rate of the circulatory system has varied due to a difference in printing density to be printed.

As shown in FIG. 2, the negative pressure control unit 230 includes two pressure adjustment mechanisms in which control pressures different from each other are set, respectively. Among the two pressure adjustment mechanisms, the one on a relatively high pressure setting side is described as H in FIG. 2, and the one on a relatively low pressure setting side is described as L in FIG. 2. The pressure adjustment mechanism H on the high pressure side is connected to the common supply flow passage 211 in the liquid ejection unit 300 through inside the liquid supply unit 220. The pressure adjustment mechanism L on the low pressure side is connected to the common collection flow passage 212 in the liquid ejection unit 300 through inside the liquid supply unit 220. In the liquid ejection unit 300, individual flow passages 213 which communicate with the common supply flow passage 211, the common collection flow passage 212, and the respective printing element substrates 10 are provided. The individual flow passages 213 include individual supply flow passages 213a and individual collection flow passages 213b. The individual flow passages 213 communicate with the common supply flow passage 211 and the common collection flow passage 212. Hence, part of the liquid caused to flow to the outside of the liquid ejection head 3 by the first circulation pump 1002 flows from the common supply flow passage 211 through internal flow passages of the printing element substrates 10 to the common collection flow passage 212 (arrows in FIG. 2). This is because a pressure difference is provided between the pressure adjustment mechanism H connected to the common supply flow passage 211 and the pressure adjustment mechanism L connected to the common collection flow passage 212, and the first circulation pump 1002 is connected to the common collection flow passage 212.

In this way, in the liquid ejection unit 300, flow of the liquid flowing through the common collection flow passage 212 and flow of the liquid flowing from the common supply flow passage 211 through each printing element substrate 10 toward the common collection flow passage 212 are generated. Hence, heat generated in each printing element substrate 10 can be discharged to the outside of the printing element substrate 10 by using the flow from common supply flow passage 211 toward the common collection flow passage 212. In addition, such a configuration makes it possible to cause the flow of the liquid even in ejection ports and pressure chambers which are not used in printing in a case where printing by the liquid ejection head 3 is conducted, and accordingly, the thickening of the liquid near the ejection ports which are not used in printing can be suppressed. In addition, the thickened liquid and foreign matters in the liquid can be discharged to the common collection flow passage 212. Hence, the liquid ejection head 3 of the present embodiment is capable of printing with high image quality at high speed.

The replenishing pump 1005 plays a role of allowing the liquid reserved in the main tank 1006 to flow into the buffer tank 1003 in a case where the amount of the liquid in the buffer tank 1003 becomes smaller than a predetermined amount. The filter 221 plays a role of suppressing mixing of foreign matters and the like into the liquid ejection head 3. Note that the configuration shown in FIG. 2 is mere an example and is not restrictive. A configuration which is not shown in FIG. 2 may be included, and a configuration which does not include part of the configuration shown in FIG. 2 may be included.

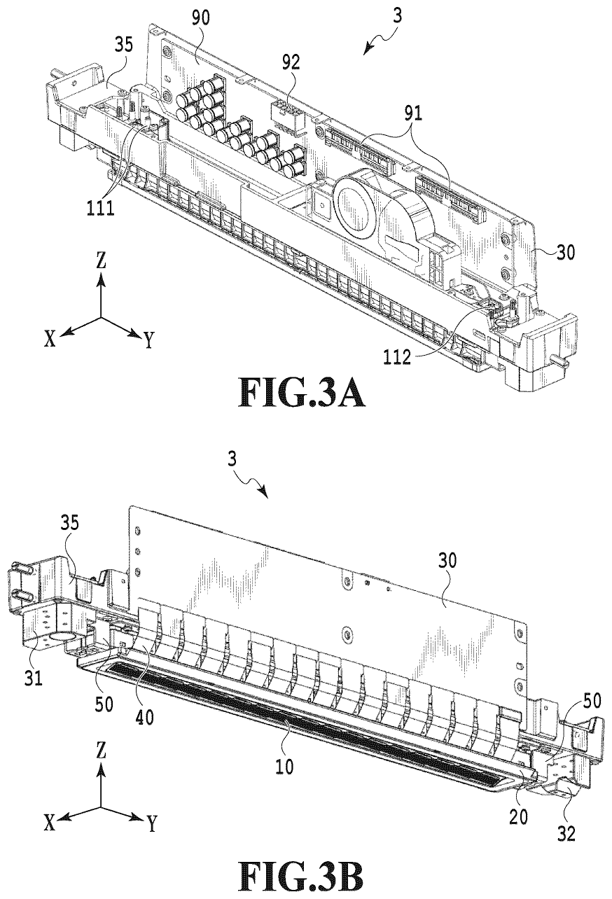

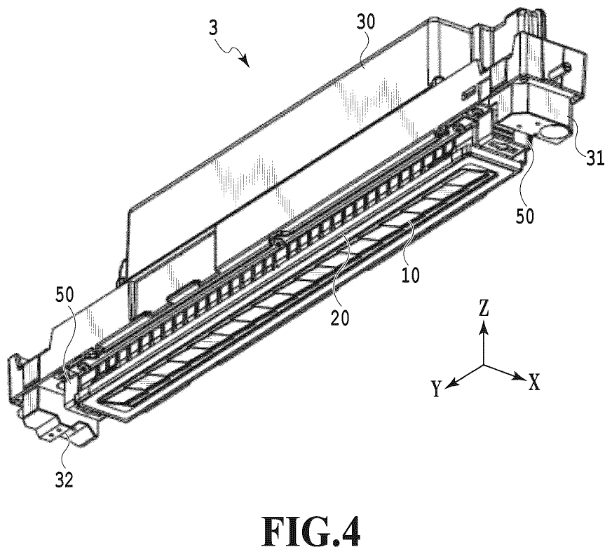

FIGS. 3A and 3B and FIG. 4 are perspective views of the liquid ejection head 3 according to the present embodiment. The liquid ejection head 3 is a line-type liquid ejection head in which a plurality of printing element substrates 10 capable of ejecting the liquid are arrayed in a straight line (arranged in line). The liquid ejection head 3 includes two or more printing element substrates 10. The liquid ejection head 3 is provided with a supporting member 35 which supports members including the printing element substrates 10.

As shown in FIGS. 3A and 3B, the liquid ejection head 3 includes the printing element substrates 10, and signal input terminals 91 and a power supply terminal 92 which are electrically connected to the printing element substrates 10 via flexible wiring substrates 40 and an electrical wiring substrate 90. The flexible wiring substrates 40 and the electrical wiring substrate 90 are electrically connected on the outer side of the head of the electrical wiring substrate 90 (on the −X direction side). The signal input terminals 91 and the power supply terminal 92 are electrically connected to the control unit of the liquid ejection apparatus 1000. The signal input terminals 91 supply ejection drive signals to the printing element substrates 10. The power supply terminal 92 supplies electric power required for ejection to the printing element substrates 10. By aggregating the wiring with an electric circuit in the electrical wiring substrate 90, the numbers of the signal input terminals 91 and the power supply terminal 92 can be made smaller than the number of the printing element substrates 10. This can reduce the number of electric connection parts which need to be removed in a case of mounting the liquid ejection head 3 to the liquid ejection apparatus 1000 or a case of replacing the liquid ejection head. A cover member 20 which covers the printing element substrates 10 and the flexible wiring substrates 40 is included around the printing element substrates 10. The electrical wiring substrate 90 is configured to be protected by a protecting member 30 from outside. This protecting member 30 also plays a role of electrical shield, and is preferably a member configured with a metal. The protecting member 30 is supported by the supporting member 35.

As shown in FIGS. 3B, the first liquid connecting unit 111 provided on one side of the liquid ejection head 3 is connected to a liquid supply system of the liquid ejection apparatus 1000, and the second liquid connecting unit 112 provided on the other side is also connected to the liquid supply system of the liquid ejection apparatus 1000. This is configured such that the liquid is supplied from the supply system of the liquid ejection apparatus 1000 to the liquid ejection head 3 via the second liquid connecting unit 112, and the liquid which has flowed through inside the liquid ejection head 3 is collected to the supply system of the liquid ejection apparatus 1000 through the first liquid connecting unit 111. In this way, the liquid can be circulated through the path of the liquid ejection apparatus 1000 and the path of the liquid ejection head 3.

As shown in FIG. 3B and FIG. 4, a first positioning member 31 is provided on one end portion of the liquid ejection head 3, and a second positioning member 32 is provided on the other end portion of the liquid ejection head 3. The first positioning member 31 includes a recess having a circular cone-shaped inclined surface. The second positioning member 32 includes a V-shaped groove portion and a planar portion. On the main body side of the liquid ejection apparatus 1000, positioning members (not shown) to the liquid ejection head are provided corresponding to the first positioning member 31 and the second positioning member 32. For example, the liquid ejection head 3 is configured to be movable in the Z direction (movable up and down). In a case where the liquid ejection head 3 moves to an ejection position such as a case of ejecting the liquid onto the print medium 2, the liquid ejection head 3 is positioned relative to the main body of the liquid ejection apparatus 1000 by the first positioning member 31 and the second positioning member 32.

As shown in FIG. 3B and FIG. 4, the liquid ejection head 3 of the present embodiment includes cap holding members 50 for holding a cap member, which is not shown. The cap holding members 50 are provided in two portions on both ends of the liquid ejection head in the longitudinal direction (Y direction) on the side of the liquid ejection head 3 where the printing element substrates 10 are provided (on the −Z direction side).

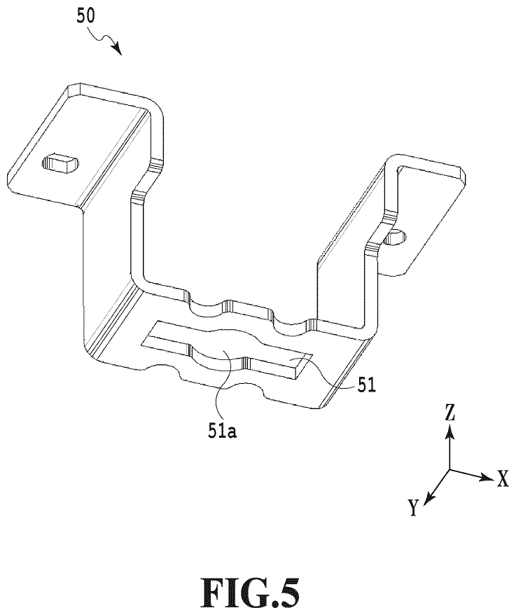

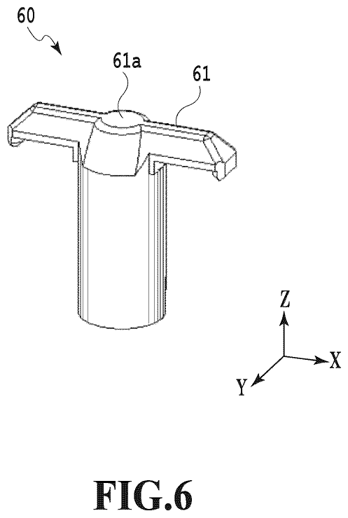

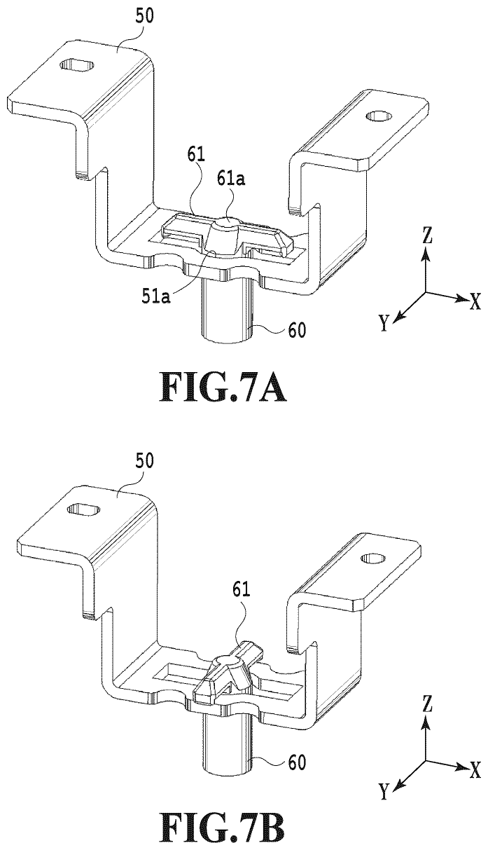

FIG. 5 is a perspective view of the cap holding member 50. The cap holding member 50 has a substantially U-shape and includes an I-shaped groove 51 which is an opening in a U-shaped bottom surface portion. FIG. 6 is a diagram showing a T-shaped member 60 which is provided in a cap member (not shown). FIGS. 7A and 7B are diagrams for explaining a configuration of holding the cap member in the liquid ejection head 3 by using the cap holding member 50 included in the liquid ejection head 3 and the T-shaped member 60 provided in the cap member. The cap holding member 50 has a substantially U-shape in such a manner as to have a void between the liquid ejection head 3 and the I-shaped groove 51 (an opening) of the cap holding member 50 to enable the penetration by the T-shaped member 60 provided on the cap member in a state where the cap holding member 50 is attached to the liquid ejection head 3.

As shown in FIG. 7A, the T-shaped member 60 of the cap member is inserted into the I-shaped groove 51 of the cap holding member 50. In the present embodiment, the length of a front end 61 (a T-shaped lateral bar portion) of the T-shaped member 60 is shorter than the length of the I-shaped groove 51. In addition, a circular cone portion formed in a center portion 61a of the front end 61 of the T-shaped member 60 has a taper shape in which the front end is smaller. Once the T-shaped member 60 is inserted into the I-shaped groove 51 of the cap holding member 50, the front end 61 of the T-shaped member 60 passes through the I-shaped groove 51, so that the front end 61 protrudes in the cap holding member 50. Here, the size of an end portion (an end portion opposite to the front end) of the taper shape of the center portion 61a of the front end 61 of the T-shaped member 60 is substantially equal to the size of a center portion 51a of the I-shaped groove 51. Hence, as the front end 61 of the T-shaped member 60 is inserted into the I-shaped groove 51, the position of the T-shaped member 60 in the X direction and the Y direction is determined as shown in FIG. 7A. That is, the position of the cap member in the X direction and the Y direction is determined. Note that in the present embodiment, the cap member including the T-shaped member 60 is assumed to be manually held in the liquid ejection head 3 by the user.

Then, after the T-shaped member 60 penetrates the I-shaped groove 51, the Z direction is restricted by rotating the T-shaped member 60 as shown in FIG. 7B. That is, the T-shaped member 60 is fixed to the cap holding member 50. In this way, the cap holding member 50 can hold the cap member through fitting of the T-shaped member 60 provided on the cap member, the fitting involving a rotating operation of the T-shaped member 60.

As shown in FIGS. 3B and FIG. 4, in the present embodiment, the liquid ejection head 3 includes two cap holding members 50. By attaching the T-shaped member 60 to each cap holding member 50, the liquid ejection head 3 can hold the cap member. In this way, it becomes possible for the liquid ejection head 3 to hold the cap member with the cap holding members 50 and the T-shaped members 60 included in the cap member. Note that an attachment surface in which the T-shaped member 60 is attached to the cap member is provided at a position lower (in the −Z direction) than a capping surface in which the cap member caps the liquid ejection surface of the liquid ejection head 3. In addition, the position at which the I-shaped groove 51 of the cap holding member 50 is provided is provided at a position higher (in the +Z direction) than the ejection surface in which the ejection ports of the liquid ejection head 3 are formed as shown in FIGS. 3B and FIG. 4. Hence, in the case where the T-shaped member 60 penetrates the I-shaped groove 51 of the cap holding member 50 and is thus fixed, the liquid ejection surface of the liquid ejection head 3 is capped by the cap member in a tight contact.

Note that the cap member may be included in the liquid ejection apparatus 1000 or may be prepared separately from the main body of the liquid ejection apparatus 1000. The cap member is used for suppressing thickening of the liquid mainly due to evaporation of the liquid from the liquid ejection unit and occurrence of sticking. Therefore, it is preferable that the contact portion of the cap member with the liquid ejection head 3 be formed of a material which can maintain close contactness and airtightness, such as a rubber or an elastomer member.

In this way, using the configuration of the present embodiment makes it possible to facilitate the work of holding the cap member on the liquid ejection head 3. In addition, in the present embodiment, in the case where there is a space in which the cap member can enter for the printing position at which the liquid ejection head 3 conducts printing on the print medium 2, it becomes possible to protect the liquid ejection head 3 with the cap member. That is, the configuration of the present embodiment makes it possible to attach the cap member to the liquid ejection head 3 without moving the liquid ejection head 3 to the position at which the cap member is provided.

Note that although an example in which the cap holding members 50 are provided as members separate from the supporting member 35 of the liquid ejection head 3 has been described in the present embodiment, the cap holding members 50 may be provided integrally with the liquid ejection head. In addition, the cap member is used for suppressing evaporation in the liquid ejection unit as mentioned above. For this reason, the cap holding members 50 are provided outward of the liquid ejection unit. In addition, in the case where the liquid ejection head 3 is a line head as in the present embodiment, there is a case where a plurality of liquid ejection heads are provided in the liquid ejection apparatus. With this point taken into consideration, it is preferable that the cap holding members 50 be provided in a longitudinal direction of the liquid ejection head 3 to achieve a reduction in size of the apparatus. In addition, as shown in FIGS. 3B and FIG. 4, the reference members (the first positioning member 31 and the second positioning member 32) for positioning with the main body of the liquid ejection apparatus 1000 are provided on both longitudinal end portions of the liquid ejection head 3. The larger the distance between these reference members in the longitudinal direction is, the higher the precision is. Therefore, a configuration in which the reference members are arranged on the outermost sides of the liquid ejection head 3 and the cap holding member 50 is arranged between each reference member and the liquid ejection unit is preferable.

As mentioned above, the configuration of the present embodiment makes it possible to cap the liquid ejection head 3 with the cap member only by moving the liquid ejection head 3 to such an extent that a space into which the cap enters is formed relative to the printing position. Therefore, even in a state where the cap holding members 50 are holding the cap member in at least one liquid ejection head 3, the printing operation becomes possible in another liquid ejection head 3.

In addition, as the method for fixing the cap holding member 50, the fixing method using the I-shaped groove 51 and the T-shaped member 60 has been described as an example; however, the fixing method is not limited to this. Any configuration may be employed as long as the configuration is capable of holding a cap member with a cap holding member provided on the liquid ejection head 3. For example, a configuration with a screw system may be employed, or a configuration with a snap-fit may be employed, or another configuration may be employed. In addition, the cap holding members provided on both ends of the liquid ejection head 3 may have the same holding form or may have different forms. For example, a configuration in which the fixing method of the cap holding member on one end of the liquid ejection head is fixing with an I-shaped groove and a T-shaped member, and the fixing method of the cap holding member on the other end is fixing using a screw system may be employed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

The present disclosure makes it possible to conduct protection of a liquid ejection head with capping in a simplified manner.

This application claims the benefit of Japanese Patent Application No. 2023-177839, filed Oct. 13, 2023, which is hereby incorporated by reference wherein in its entirety.

What is claimed is:

1. A liquid ejection head configured to be attachable to and detachable from a liquid ejection apparatus, comprising a holding member capable of holding a cap member configured to protect a liquid ejection surface.

2. The liquid ejection head according to claim 1, wherein the holding member is configured with a member different from a supporting member of the liquid ejection head.

3. The liquid ejection head according to claim 1, wherein the holding member is provided outward of the liquid ejection surface.

4. The liquid ejection head according to claim 1, wherein the holding member is provided on each of end portions of the liquid ejection head in a longitudinal direction.

5. The liquid ejection head according to claim 1, further comprising a reference member configured to position the liquid ejection head to the liquid ejection apparatus, wherein
the holding member is provided between the reference member and the liquid ejection surface.

6. The liquid ejection head according to claim 1, wherein the liquid ejection head is a line head including two or more printing element substrates.

7. The liquid ejection head according to claim 1, wherein
the holding member includes a groove, and
the holding member holds the cap member through fitting of a member provided on the cap member, the fitting involving a rotating operation of the member.

8. The liquid ejection head according to claim 7, wherein a plane on which the groove is provided is provided at a position higher than the liquid ejection surface.

9. An elongated head having a length over a printing width of a print medium and being configured to be attachable to and detachable from a printing apparatus, comprising:
a printing surface including an ejection port configured to eject a liquid over the printing width; and
a holding member provided near each of ends of the elongated head for maintaining a protection state by a cap member configured to protect the printing surface of the elongated head, wherein
an opening is provided in the holding member, and
the opening is configured to allow a member provided on the cap member to penetrate the opening and maintain the protection state of the printing surface of the elongated head by the cap member in cooperation with the member.

10. The elongated head according to claim 9, wherein the holding member has a substantially U-shape in such a manner as to have a void between the elongated head and the opening of the holding member to enable the penetration by the member provided on the cap member in a state where the holding member is attached to the elongated head.

11. The elongated head according to claim 9, wherein
the opening provided in the holding member has a substantially I-shape,
the member provided on the cap member has a substantially T-shape, and
after the member penetrates the opening, the member is rotated to engage with the opening to maintain the protection state by the cap member on the printing surface of the elongated head.
